(19) United States
(12) Patent Application Publication
(10) Pub. No.: US 2007/0182559 A1
(43) Pub. Date: Aug. 9, 2007

(54) RFID ANTENNA ON MULTIPLE SIDES OF 3-D PACKAGING

(75) Inventors: DANIEL P. LAWRENCE, Ann Arbor, MI (US); KEVIN ASHTON, Boston, MA (US); DANIEL GAMOTA, Palatine, IL (US); MICHAEL FEIN, Ann Arbor, MI (US); JOHAN SIDEN, Sundsvall (SE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/532,214

(22) Filed: Sep. 15, 2006

Related U.S. Application Data
(60) Provisional application No. 60/717,155, filed on Sep. 15, 2005.

(51) Int. Cl. G08B 13/14

(52) U.S. Cl. 340/572.7; 340/572.8

(57) ABSTRACT

An RFID antenna is fabricated to operate in three dimensions. An antenna including a first conductive trace and at least one second conductive trace is formed on an unfolded packaging substrate having a first surface and at least one second surface. An integrated circuit is connected across the conductive traces. The unfolded packaging substrate is formed into a three-dimensional package having multiple sides. For example, the unfolded packaging substrate is folded into a cube-shaped container having six sides. The integrated circuit is formed on a first side, while portions of the first and second conductive traces may be formed on both the first side and at least one second side. In this manner, the antenna is three-dimensional and operable to more effectively communicate with a three-dimensional electromagnetic field.

### CROSS-REFERENCE TO RELATED APPLICATIONS

This patent application claims priority from U.S. Provisional Patent Application No. 60/717,155, filed Sep. 15, 2005, and entitled “RFID ANTENNA ON MULTIPLE SIDES OF 3-D PACKAGING”.

### FIELD OF THE INVENTION

The present invention relates to radio frequency identification (RFID) antennas, and more particularly to application of RFID antennas to packaging.

### BACKGROUND OF THE INVENTION

Integrated circuits (ICs) are the basic building blocks that are used to create electronic devices. Continuous improvements in IC process and design technologies have led to smaller, more complex, and more reliable electronic devices at a lower cost per function. As performance has increased and size and cost have decreased, the use of ICs has expanded significantly.

One particular type of IC that would benefit from inexpensive mass production involves the use of radio frequency identification (RFID) technology. RFID technology incorporates the use of electromagnetic or electrostatic radio frequency (RF) coupling. Traditional forms of identification such as barcodes, cards, badges, tags, and labels have been widely used to identify items such as access passes, parcels, luggage, tickets, and currencies. However, these forms of identification may not protect items from theft, misplacement, or counterfeit, nor do they allow “touch-free” tracking.

More secure identification forms such as RFID technology offer a feasible and valuable alternative to traditional identification and tracking. RFID does not require physical contact and is not dependent on line-of-sight for identification. RFID technology is widely used today at lower frequencies, such as 13.56 MHz, in security access and animal identification applications. Higher-frequency RFID systems ranging between 850 MHz and 2.5 GHz have recently gained acceptance and are being used in applications such as vehicular tracking and toll collecting, and in business logistics such as manufacturing and distribution.

Traditionally, antennae for RFID tags are designed primarily to function as collectors of RF energy to promote tag function. In some applications, a printing process is used to print conductive traces on a substrate to form a functional electronic structure such as an RFID antenna. The RFID antenna absorbs, couples with, and/or reflects radio frequency signals from a transmitter and provides a signal and power to an attached integrated circuit.

The radiation, or gain pattern, of the antenna impacts the performance of the antenna. RFID tags with traditional antennae are applied inside a package or product, applied underneath a self adhesive label containing graphics, and/or located on top of the package or product. The RFID tags are typically applied to a single surface of a multi-surface package. The antenna structure is two-dimensional and is inherently limited in the directionality of the radiation pattern. In other words, the two-dimensional antenna structure has a void in one dimension. As a result, the antenna device is sensitive to the orientation with the reader antenna. In other words, the orientation of the antenna is limited to the position of the package in relation to the reader antenna. In addition to orientation sensitivity, materials within the package, such as metals and/or liquids, may further interfere with the operation of the antenna.

### SUMMARY OF THE INVENTION

An RFID system comprises a packaging substrate that has a first surface and at least one second surface. An antenna is formed on the packaging substrate and includes a first conductive trace and at least one second conductive trace, wherein at least one of the conductive traces is formed on the first surface and the at least one second surface. An integrated circuit is connected across the first conductive trace and the at least one second conductive trace on the first surface. The packaging substrate has an unfolded state wherein the first surface and the at least one second surface are substantially coplanar. The packaging substrate has a folded state wherein the first surface and the at least one second surface are not coplanar.

In another aspect of the invention, a method of printing is disclosed for printing an RFID antenna operable to function in three dimensions comprises forming an antenna that includes a first conductive trace and at least one second conductive trace on an unfolded packaging substrate having a first surface and at least one second surface. An integrated circuit is connected across the first conductive trace and the at least one second conductive trace. The unfolded packaging substrate is formed into a package wherein the first surface and the at least one second surface are not coplanar. The integrated circuit and portions of the first conductive trace and the at least one second conductive trace are formed on the first surface and a portion of at least one of the first and/or second conductive traces is formed on the at least one second surface.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of an RFID antenna according to the prior art;

FIG. 2 is a perspective view of a package including an RFID antenna according to the prior art;

FIG. 3A is a perspective view of an antenna formed on an unfolded package substrate according to the present invention;

FIG. 3B is a perspective view of the antenna structure formed on the folded package of FIG. 3A according to the present invention;

FIG. 4A is a perspective view of an alternative embodiment of the antenna formed on an unfolded package substrate according to the present invention;

FIG. 4B is a perspective view of an alternative embodiment of the antenna structure formed on a folded package according to the present invention;

FIG. 5A is a perspective view of an alternative embodiment of the antenna formed on an unfolded package substrate according to the present invention;

FIG. 5B is a perspective view of an alternative embodiment of the antenna structure formed on a folded package according to the present invention;

FIG. 6A is a perspective view of an alternative embodiment of the antenna formed on an unfolded package substrate according to the, present invention;

FIG. 6B is a perspective view of an alternative embodiment of the antenna structure formed on a folded package according to the present invention;

FIG. 7A is a perspective view of an alternative embodiment of the antenna formed on an unfolded package substrate according to the present invention; and

FIG. 7B is a perspective view of an alternative embodiment of the antenna structure formed on a folded package according to the present invention.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity, the same reference numbers will be used in the drawings to identify similar elements.

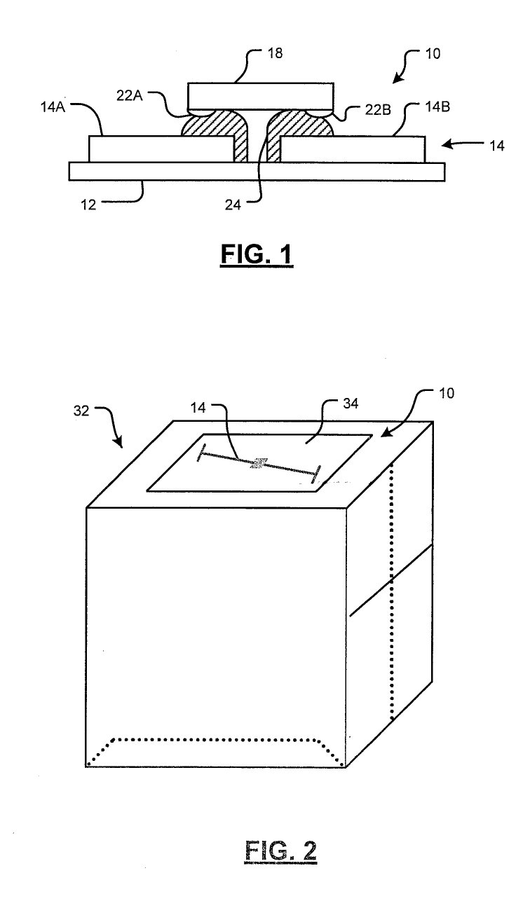

Referring now to FIG. 1, an RFID system 10 includes a substrate 12 having an antenna 14 that is printed thereon and/or otherwise attached thereto. The term formed is used herein in a general manner to describe placement of an antenna on a substrate. It may refer to printing, depositing, etching, sputtering, flowing, etc. The antenna 14 includes first and second antenna components 14A and 14B. While two components are shown, additional antenna components can be used. A transmitter is typically implemented using an integrated circuit (IC) 18 and is electronically programmed with a unique identification (ID) and/or information about the item. The IC 18 typically includes conductors 22A and 22B. The conductors 22A and 22B are formed on one side of the IC 18 and are connected by conductive adhesive 24 to the antenna components 14A and 14B, respectively. In use, a transceiver containing a decoder communicates with transmitters that are within range of the RFID system 10. The IC 18 may be connected to one or more antennas 14. Alternatively, the antenna 14 may have more than two antenna components.

The RFID system 10 is typically applied to a single surface 30 of a package 32 as shown in FIG. 2. The antenna 14 is arranged two-dimensionally on the surface 30. For example, the antenna 14 may be applied as a label 34. In this manner, the performance of the antenna 14 is affected by the orientation of the antenna 14 relative to a nearby reader antenna (not shown). The reader antenna produces a three-dimensional electromagnetic field. The antenna 14 interacts with the electromagnetic fields from the reader antenna in order to acquire the energy necessary to operate. However, the planar structure of the antenna 14 only utilizes two dimensions to acquire energy from the three-dimensional electromagnetic field.

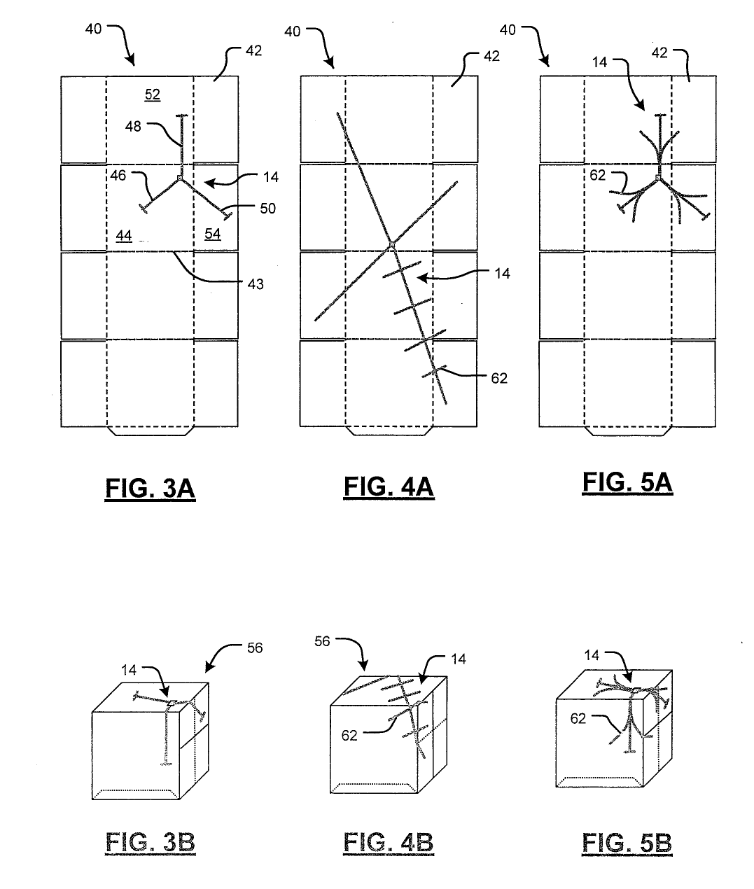

The present invention integrates a three-dimensional antenna structure with product packaging, resulting in substantial improvements to orientation sensitivity, environmental robustness, and potential antenna design innovation. The antenna 14 is printed directly to a package substrate 40 prior to folding the package substrate 40 into its final form as shown in FIG. 3A. The antenna 14 is printed on two or more sides 42 of the package substrate 40. The antenna 14 is positioned so that the IC 18 can be centrally located relative to the antenna 14. For example, the antenna 14 is positioned so that the IC 18 is located on a first side 44, proximate an edge 43 of the first side 44. A first antenna component 46 extends from the IC 18 and is located entirely on the first side 44. Second and third antenna components 48 and 50 extend from the IC 18 and are substantially located on second and third sides 52 and 54, respectively. Therefore, it can be seen that the present method also allows the antenna 14 to be larger than a single side of the package substrate would accommodate.

After the antenna 14 is printed on the package substrate 40, the package substrate 40 is folded into a package 56 as shown in FIG. 3B. In this manner, the antenna 14 is patterned on multiple sides of the package 56 in a three-dimensional structure. With the antenna 14 printed on multiple sides of the package 56, the likelihood that least a portion of the antenna 14 will be in a plane wherein it most effectively couples with a three-dimensional RF field generated by a reader antenna is significantly increased. The three-dimensional structure of the antenna 14 therefore assists in the functionality of the RFID tag by providing additional energy input to the IC 18, which is a result of enhanced gain.

Additionally, ultra-high frequency (UHF) antennas generally function at ½ or ¼ of the RF wavelength used to communicate with or power the RFID tag due to size limitations. Although full-wave antennae provide higher gain, the size constraints related to printing conventional antennae on a single side of a package limit the practicality of full-wave antennae. Three-dimensional antennae as described herein are able to cover larger areas, providing full or, in certain applications, double wavelength antenna capabilities.

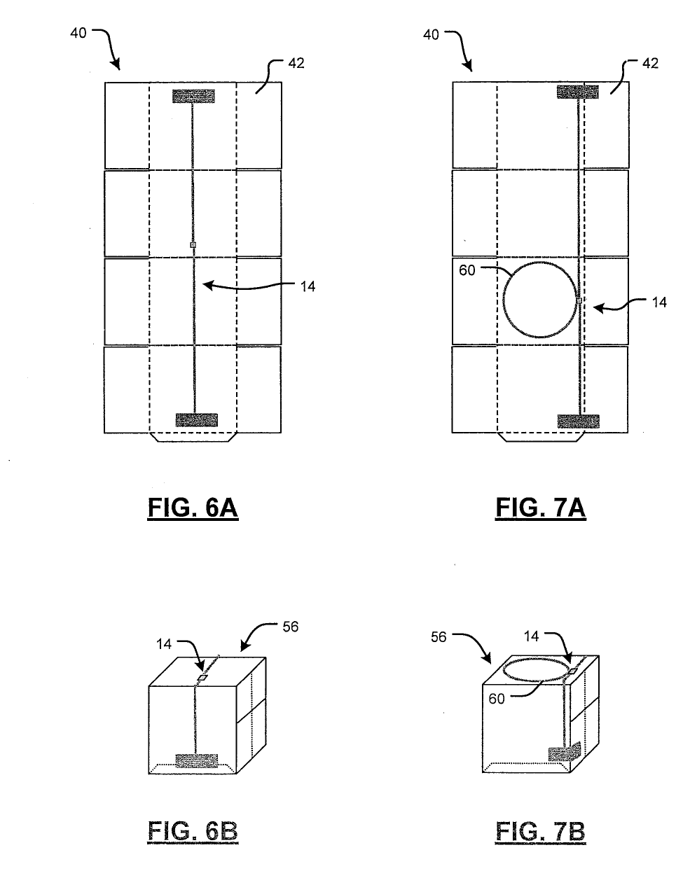

Further embodiments of antennae 14 printed on two or more sides 42 of package substrates 40 are shown in FIGS. 4A, 5A, 6A, and 7A. The package substrates 40 of FIGS. 4A, 5A, 6A, and 7A are shown folded into packages 56 in FIGS. 4B, 5B, 6B, and 7B, respectively. The antennae 14 may be printed in additional configurations not shown. For example, the antennae 14 may be printed on an outside surface of the package 56, and inside surface of the package 56, or elsewhere within the interior of the package 56. Three-dimensional antennae provide other possible antenna designs that are known to those skilled in the art that have not been practical due to size and design constraints. For example, the antennae 14 may be designed to include features including, but not limited to, an inductive loop 60 as shown in FIGS. 7A and 7B, meander lines 62 as shown in FIGS. 4A, 4B, 5A, and 5B, and/or capacitive loads (not shown).

These antennas can be manufactured using printing processes, such as, but not limited to: gravure, offset gravure, flexography, offset lithography, letterpress, ink jet, flatbed screen, and/or rotary screen printing. Furthermore, the antenna can be patterned using etching, stamping, or electrochemical deposition (such as electrolysis or electroplating) of metals.

Those skilled in the art can now appreciate from the foregoing description that the broad teachings of the current invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. An RFID system, comprising:
a packaging substrate that has a first surface and at least one second surface;
an antenna formed on the packaging substrate that includes a first conductive trace and at least one second conductive trace, wherein at least one of the conductive traces is formed on the first surface and the at least one second surface; and
an integrated circuit connected across the first conductive trace and the at least one second conductive trace on the first surface,
wherein the packaging substrate has an unfolded state wherein the first surface and the at least one second surface are substantially coplanar, and has a folded state wherein the first surface and the at least one second surface are not coplanar.

2. The RFID system of claim 1 further comprising at least one of an inductive loop and/or a capacitive load formed on the at least one second surface.

3. The RFID system of claim 1 wherein the antenna is formed on at least one of an internal surface and/or an external surface of the packaging substrate.

4. The RFID system of claim 1 wherein the integrated circuit is located proximate a border between the first surface and the at least one second surface.

5. The RFID system of claim 1 wherein the antenna is a full wavelength antenna.

6. An RFID system, comprising:
a packaging substrate having a first surface on a first plane and a second surface on a second plane;
an antenna formed on the packaging substrate that includes a first conductive trace and at least one second conductive trace; and
an integrated circuit that is connected across the first conductive trace and the at least one second conductive trace on the first surface, wherein at least one of the conductive traces extends outward from the integrated circuit and is formed on the first surface and the second surface.

7. A method of printing an RFID antenna operable to function in three dimensions, comprising:
forming an antenna that includes a first conductive trace and at least one second conductive trace on an unfolded packaging substrate having a first surface and at least one second surface;
connecting an integrated circuit across the first conductive trace and the at least one second conductive trace; and
forming the unfolded packaging substrate into a package wherein the first surface and the at least one second surface are not coplanar, and wherein the integrated circuit and portions of the first conductive trace and the at least one second conductive trace are formed on the first surface and a portion of at least one of the first and/or the at least one second conductive trace is formed on the at least one second surface.

8. The method of claim 7 wherein the step of forming includes folding the unfolded packaging substrate into a three-dimensional package.

9. The method of claim 7 wherein the integrated circuit and the first conductive trace and the at least one second conductive trace are formed on at least one of an internal and/or an external surface of the package.

10. The method of claim 7 further comprising forming at least one of an inductive loop and/or a capacitive load on the unfolded packaging substrate, wherein after performing the step of forming the unfolded packaging substrate into a package, said inductive loop and/or capacitive load is located on at least one of the first surface and/or the at least one second surface.

11. The method of claim 7 wherein the integrated circuit and portions of the first conductive trace and the at least one second conductive trace are formed on an internal surface of the package and a portion of at least one of the first conductive trace and/or the second conductive trace is formed on an external surface of the package.
